(19) United States
(12) Patent Application Publication
(10) Pub. No.: US 2024/0292862 A1
(43) Pub. Date: Sep. 5, 2024

(54) AUTOMATED ADDITIVE ASSEMBLY FOR A MICRO-PUREE MACHINE

(71) Applicant: SharkNinja Operating LLC, Needham, MA (US)

(72) Inventors: Noah William Weinstock, Boston, MA (US); Nick Lerwill, London (GB); Pierce James Barnard, Manly (AU)

(73) Assignee: SharkNinja Operating LLC, Needham, MA (US)

(21) Appl. No.: 18/595,156

(22) Filed: Mar. 4, 2024

Related U.S. Application Data
(60) Provisional application No. 63/488,312, filed on Mar. 3, 2023.
(60) Provisional application No. 63/579,122, filed on Aug. 28, 2023.

(51) Int. Cl. A23G 9/28; A23G 9/12

(52) U.S. Cl. CPC A23G 9/282; A23G 9/12

(57) ABSTRACT

An automated additive assembly for a micro-puree machine has a body including a reservoir configured for holding an additive ingredient. A channel is defined through the body, and a passage is in fluid communication with the reservoir and the channel. A plunger is configured for movement within the reservoir. Movement of the plunger within the reservoir in a first direction forces the additive ingredient through the channel such that the additive ingredient is combined with the processed ingredients extruded through the nozzle.

### CROSS-REFERENCE TO RELATED APPLICATIONS

This application claims priority to and benefit of U.S. Provisional Application No. 63/488,312, filed on Mar. 3, 2023, entitled AUTOMATED ADDITIVE ASSEMBLY FOR A MICRO-PUREE MACHINE, and U.S. Provisional Application No. 63/579,122, filed on Aug. 28, 2023, entitled AUTOMATED ADDITIVE ASSEMBLY FOR A MICRO-PUREE MACHINE, the entire contents of which are incorporated herein by reference for all purposes.

### FIELD

The present disclosure relates to a food processing device and, more particularly, to a micro-puree machine that allows for processing, aeration, and extrusion of ingredients.

### BACKGROUND

Domestic kitchen appliances that are intended to make ice creams, gelatos, frozen yogurts, sorbets, and the like are known in the art. Typically, a user adds a series of non-frozen ingredients to a mixing bowl, which often has been previously cooled, for example, in a freezer. The ingredients are then churned by a one or more paddles (sometimes referred to as dashers) while a refrigeration mechanism simultaneously freezes the ingredients. These devices have known shortcomings including, but not limited to, the amount of time and effort required by the user to complete the ice cream-making process. Machines of this nature are impractical for preparing most non-dessert food products.

An alternative type of machine known for making a frozen food product is what is referred to herein as a micro-puree machine. Typically, machines of this nature spin and plunge a blade into a pre-frozen ingredient or combination of ingredients. While able to make frozen desserts like ice creams, gelatos, frozen yogurts, sorbets and the like, micro-puree style machines can also prepare non-dessert types of foods such as non-dessert purees and mousses.

### SUMMARY

In some embodiments, the disclosure describes an automated additive assembly for a micro-puree machine for pushing additive ingredients to be injected into the extruded product at the nozzle location. Advantageously, the additive assembly may reduce user interaction with the additive ingredients and the with machine housing to produce the final product.

In embodiments, the automated additive assembly of this disclosure includes a body including a reservoir configured for holding an additive ingredient. The body has a channel alignable with a nozzle of the micro-puree machine. A plunger is configured for movement within the reservoir. Movement of the plunger within the reservoir in a first direction forces the additive ingredient into the channel.

In further embodiments, the body includes a passage in fluid communication with the reservoir and the channel. Movement of the plunger within the reservoir in the first direction forces the additive ingredient through the passage. In embodiments, the passage includes a circumferential groove at least partially surrounding and in fluid communication with the channel. In embodiments, the automated additive assembly further includes a lid configured to be secured to an open first end of the body such that an interface between the lid and the body forms a seal. In embodiments, the lid defines an opening in communication with the channel. The opening is configured to fluidly connect to the nozzle. In embodiments, a connector on the plunger extends through an opening in the reservoir. In embodiments, the connector is configured for attachment to a rod for moving the plunger within the reservoir. In embodiments, the automated additive assembly is configured such that forcing the additive ingredient into the channel combines the additive ingredient with the processed ingredients extruded through the nozzle.

In other embodiments, a micro-puree machine of this disclosure includes a bowl attachable to the micro-puree machine. The bowl is configured to house primary ingredients within an interior volume of the bowl. The micro-puree machine also includes a blade for processing the primary ingredients within the interior volume of the bowl. The micro-puree machine also includes a nozzle for extruding the processed ingredients from the interior volume of the bowl. The micro-puree machine also includes an automated additive assembly having a body including a reservoir configured for holding an additive ingredient. The body has a channel alignable with the nozzle. A plunger is configured for movement within the reservoir. Movement of the plunger within the reservoir in a first direction forces the additive ingredient into the channel.

In further embodiments, the body includes a passage in fluid communication with the reservoir and the channel. Movement of the plunger within the reservoir in the first direction forces the additive ingredient through the passage. In embodiments, the passage includes a circumferential groove at least partially surrounding and in fluid communication with the channel. In embodiments, the micro-puree machine further includes a lid configured to be secured to an open first end of the body such that an interface between the lid and the body forms a seal. In embodiments, the lid defines an opening in communication with the channel. The opening is configured to fluidly connect to the nozzle. In embodiments, a connector on the plunger extends through an opening in the reservoir. In embodiments, the connector is configured for attachment to a rod for moving the plunger within the reservoir. In embodiments, the micro-puree machine is configured such that the forcing the additive ingredient into the channel combines the additive ingredient with the processed ingredients extruded through the nozzle.

Embodiments of a method of adding an additive ingredient to processed ingredients in a micro-puree machine of this disclosure include processing the ingredients within a bowl of the micro-puree machine. The bowl is configured to allow extrusion of the processed ingredients through a nozzle. The method also includes adding an additive ingredient to the processed ingredients with an automated additive assembly. The automated additive assembly includes a body including a reservoir configured for holding an additive ingredient. The body has a channel alignable with the nozzle. A plunger is configured for movement within the reservoir. Movement of the plunger within the reservoir in a first direction forces the additive ingredient into the channel.

In further embodiments, the method includes adding the additive ingredient to the reservoir. In embodiments, the method includes moving the plunger through the reservoir such that the additive ingredient is moved out of the reservoir and extruded from the channel while the processed ingredients are extruded through the nozzle. In embodiments, the method includes operatively connecting the plunger to a rod for moving the plunger through the reservoir.

A reading of the following detailed description and a review of the associated drawings will make apparent the advantages of these and other structures. Both the foregoing general description and the following detailed description serve as an explanation only and do not restrict aspects of the disclosure as claimed.

### BRIEF DESCRIPTION OF THE DRAWINGS

Reference to the detailed description, combined with the following figures, will make the disclosure more fully understood, wherein:

FIG. 1A shows an isometric view of a micro-puree machine, according to some embodiments of the disclosure.

FIG. 1B shows the micro-puree machine of FIG. 1A with the bowl assembly disassembled from the housing, according to some embodiments of the disclosure.

FIGS. 1C-1G illustrate embodiments of extrusion assemblies, bowl assemblies, and/or nozzle assemblies of the micro-puree machine of FIG. 1A, according to some embodiments of the disclosure;

FIG. 2A illustrates a portion of another micro-puree machine, according to some embodiments of the disclosure;

FIG. 2B illustrates a reversible bowl assembly that may be coupled to the micro-puree machine of FIG. 2A, according to some embodiments of the disclosure;

FIG. 3A shows another reversible bowl assembly, according to some embodiments of the disclosure.

FIG. 3B shows a blade of the reversible bowl assembly of FIG. 3A, according to some embodiments of the disclosure;

FIG. 3C is a cut-away view of the reversible bowl assembly and first lid of FIGS. 3A and 3B, according to some embodiments of the disclosure;

FIG. 3D shows a detailed view of an embodiment of a plunger coupled to the underside of second lid, according to some embodiments of the disclosure;

FIGS. 4A and 4B illustrate the use of the reversible bowl assembly of FIGS. 3A-3D, according to some embodiments of the disclosure;

FIG. 5 illustrates an aeration system, according to some embodiments of the disclosure;

FIGS. 6A-6C illustrate an automated additive assembly for use with the micro-puree machine of FIG. 1A, according to some embodiments of this disclosure;

FIG. 6D-6F further illustrate components of the additive assembly of FIGS. 6A-6C, according to some embodiments of the disclosure;

FIGS. 6G-6K illustrate the use of the additive assembly of FIGS. 6A-6C, according to some embodiments of the disclosure; and

FIG. 7 illustrates the use of another automated additive assembly, according to some embodiments of this disclosure.

### DETAILED DESCRIPTION

In the following description, like components have the same reference numerals, regardless of different illustrated embodiments. To illustrate embodiments clearly and concisely, the drawings may not necessarily reflect appropriate scale and may have certain structures shown in somewhat schematic form. The disclosure may describe and/or illustrate structures in one embodiment, and in the same way or in a similar way in one or more other embodiments, and/or combined with or instead of the structures of the other embodiments.

In the specification and claims, for the purposes of describing and defining the invention, the terms “about” and “substantially” represent the inherent degree of uncertainty attributed to any quantitative comparison, value, measurement, or other representation. The terms “about” and “substantially” moreover represent the degree by which a quantitative representation may vary from a stated reference without resulting in a change in the basic function of the subject matter at issue. Open-ended terms, such as “comprise,” “include,” and/or plural forms of each, include the listed parts and can include additional parts not listed, while terms such as “and/or” include one or more of the listed parts and combinations of the listed parts. Use of the terms “top,” “bottom,” “above,” “below” and the like helps only in the clear description of the disclosure and does not limit the structure, positioning and/or operation of the disclosure in any manner.

Notably, the mechanisms and techniques described herein may be used to configure a machine to process (e.g., micro-puree and perhaps aerate) and extrude ice cream and other frozen ingredients. That is, both the processing and extrusion functions can be performed by a single machine. In such a machine, a same shaft may be used to drive a blade to process the frozen ingredients in a bowl (i.e., a container) and to drive a plunger to extrude the processed ingredients from the bowl. Further, such a machine may include a user interface enabling a user to control the timing of the performance of each function. In some implementations of such a machine, a first shaft may be used to drive processing and a second shaft may be used to drive extrusion, and such implementations may be considered to have a first sub-system or module for processing and a second sub-system or module for extrusion.

In some embodiments, a single lid may be provided (e.g., on an open end of the bowl) that houses (or is coupled to) a blade for processing ingredients, and that also houses (or is coupled to) a plunger for extruding the processed ingredients. In such embodiments, a single shaft driven by one or more motors (e.g., one motor for driving rotation of blade; the other motor for driving linear movement of the driven shaft along its axis) may drive both the processing that uses the blade and the extrusion that uses the plunger, as described in more detail elsewhere herein, and an end of the bowl opposite the lid may include an opening for extrusion of the processed ingredients from the bowl.

In other embodiments, to enable the performance of both functions, the user may flip the processing bowl from a first arrangement, in which the driven shaft engages a blade at a first end of the processing bowl (e.g., the blade housed in or coupled to a first lid at a first open end of the processing bowl), to a second arrangement, in which the driven shaft engages a plunger at a second end of the processing bowl (e.g., the plunger housed in or coupled to a second lid at an open second end of the processing bowl), as described in more detail herein. In such embodiments, the first lid also may include an opening for extruding the ingredients from the bowl during extrusion using the plunger in the second arrangement. Further, in such embodiments, a single shaft driven by one or more motors may drive both the processing by use of the blade and the extrusion by use of the plunger, as described in more detail elsewhere herein.

In other embodiments, to enable the performance of both functions, the user may replace a first lid (e.g., housing or coupled to a blade) for processing from an open end of the processing bowl with a second lid (e.g., housing or coupled to a plunger) for extruding, as described in more detail elsewhere herein. In such embodiments, a single shaft driven by one or more motors may drive both the processing by use of the blade and the extrusion by use of the plunger, or alternatively, a separate shaft may be used for extruding, in which such separate shaft drives the plunger, as described in more detail elsewhere herein.

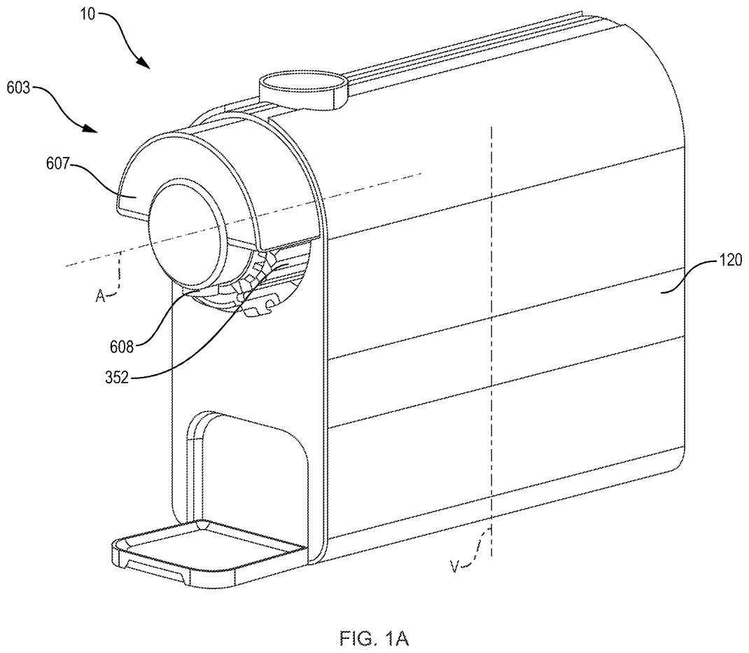

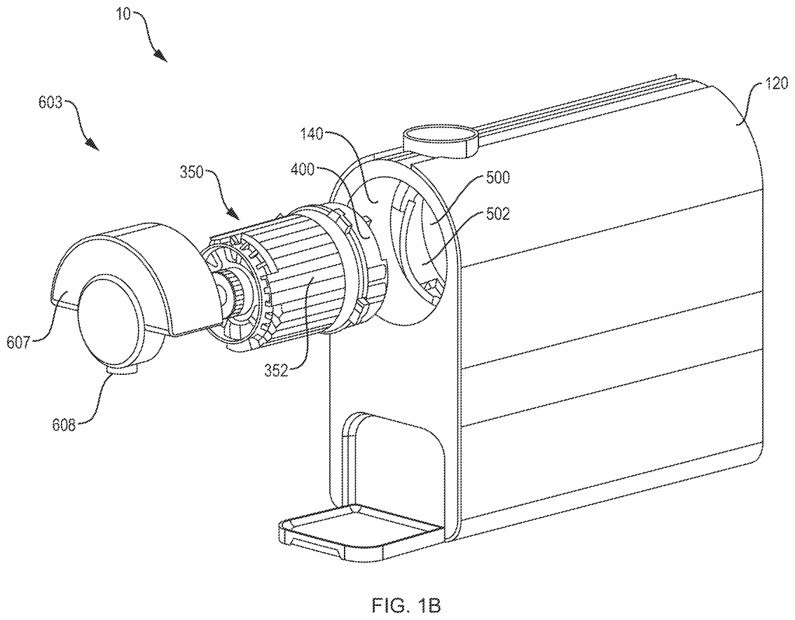

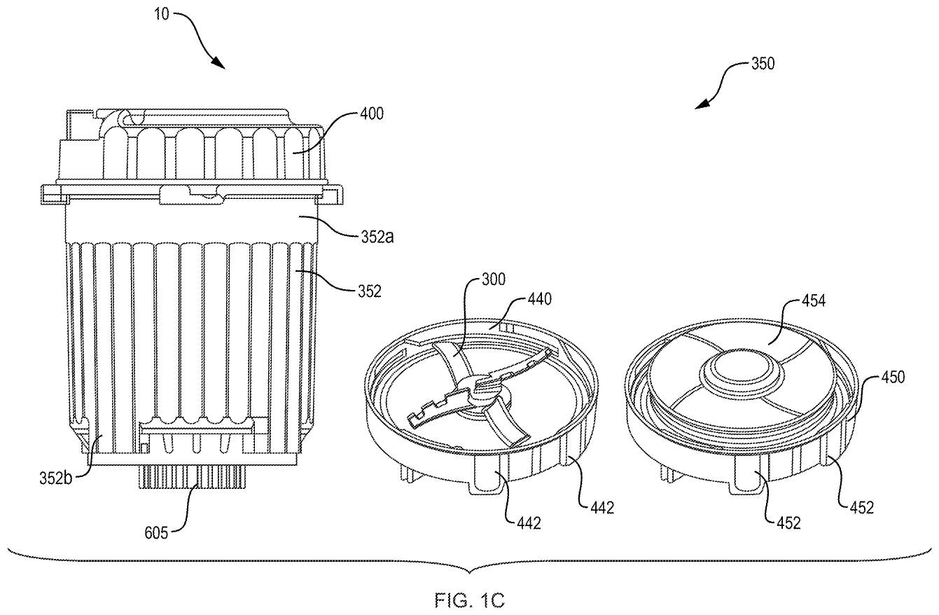

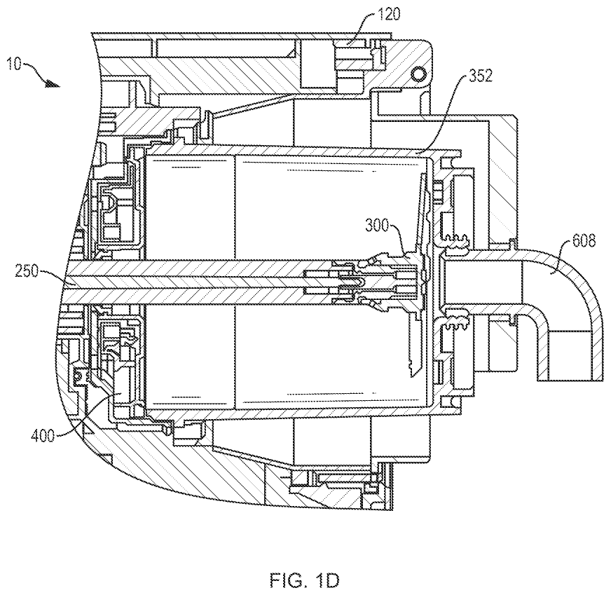

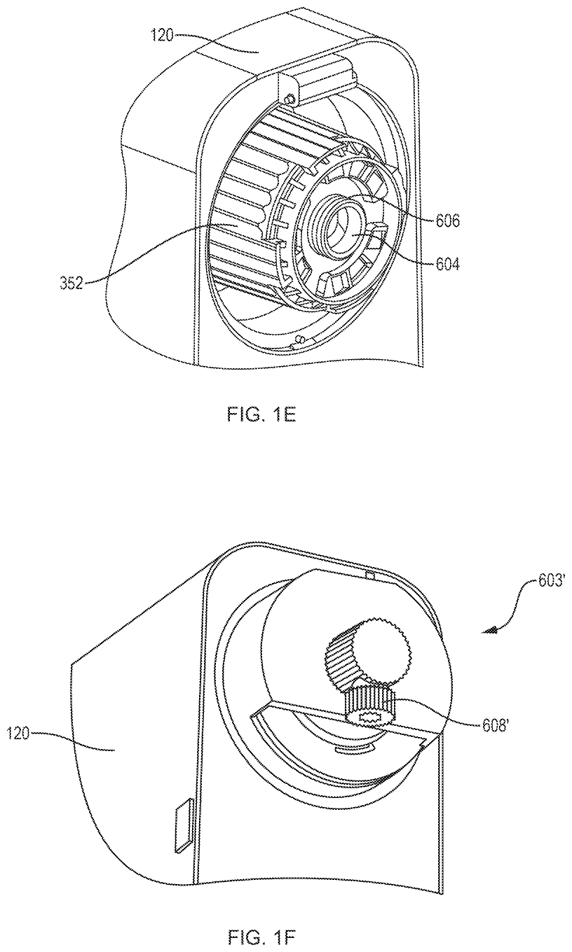

FIG. 1A shows an isometric view of a micro-puree machine 10 according, to some embodiments of the disclosure. FIG. 1B shows the micro-puree machine 10 of FIG. 1A with the bowl assembly 350 disassembled from the housing 120 according to some embodiments of the disclosure. FIGS. 1C-1G illustrate embodiments of the extrusion assemblies, bowl assemblies, and/or nozzle assemblies, according to some embodiments of the disclosure.

The micro-puree machine 10 may include a housing 120, which may include a user interface (not shown) for receiving user inputs to control the micro-puree machine 10 and/or display information. The micro-puree machine 10 also may include a bowl assembly 350 and a nozzle assembly 603. The combination of a bowl assembly 350, which may include a lid 400 configured for extruding, and a nozzle assembly 605 may be referred to herein as an extrusion assembly. The nozzle assembly 603 may include a nozzle housing 607 and a nozzle 608.

The bowl assembly 350 may include a bowl 352 configured to contain one or more processed ingredients, ingredients to be processed, or ingredients being processed. A user may couple the bowl assembly 350 to the housing 120 by rotating the bowl assembly 350 relative to the housing 120 (e.g., using screwing threads or a bayonet connection), or by another coupling mechanism and/or technique. The bowl assembly 350 may be assembled to the housing 120 such that a central axis A of the bowl assembly 350 extends perpendicular to a vertical axis V of the housing 120, as shown. However, the disclosure contemplates that the bowl assembly 350 may be assembled to the housing 120 such that the central axis A extends at an angle between 0 and 90° to the vertical axis, for example, as described in U.S. Pat. No. 11,759,057 to SharkNinja Operating, LLC, the entire contents of which are hereby incorporated by reference (the '057 patent), or such that the central axis of the bowl assembly 350 extends parallel to the vertical axis V, for example, as described in U.S. Pat. No. 11,871,765 to SharkNinja Operating, LLC, the entire contents of which are hereby incorporated by reference (the '756 patent). In embodiments, the bowl 352 of the bowl assembly 350 can be manufactured from a disposable material to enhance the convenience of using the micro-puree machine 10. Further, the bowl 352 can be sold as a stand-alone item and can also be prefilled with ingredients to be processed during use of the micro-puree machine 10.

As shown in FIG. 1B, the housing 120 may including a coupling 500 disposed within an opening 140 of the housing 120. An inner surface 502 of the coupling 500 may comprise locating and locking elements for positioning and connecting the reversible bowl assembly 350 to the coupling 500 in two different configurations, as described elsewhere herein. The micro-puree machine 10 may further include a nozzle 608 couplable to the bowl assembly 350 for extruding processed ingredients from the bowl assembly 350. The nozzle 608 may be arranged such that the ingredients are extruded in a vertically downward direction such that a user can place an ice cream cone, cup, bowl, or other edible or non-edible receptacle underneath the nozzle to receive extruded ingredients. The disclosure also contemplates that multiple nozzle shapes may be provided to allow for user customizability. For example, multiple nozzles may be included on a rotatable dial that allows the user to select the desired nozzle shape. In further embodiments, the extrude function may be integrated into a program on the user interface with a predetermined translation speed/flow rate.

As shown in FIG. 1C, the first end 352a of the bowl 352 may be configured to couple to both a first lid 440 and the second lid 450. The first lid 440 may include a blade 300 for processing ingredients, for example, a blade as described in the '765 application. When the lid 440 is coupled to the bowl 352 (e.g., via reciprocal threading on the bowl and lid), the bowl assembly 350 may be considered to be in a processing configuration, and may be coupled to the housing via coupling 500. The lid 440 may have locating and locking elements 442 on its exterior sidewall configured to couple to the locating and locking elements on the inner surface 502 of the coupling 500. The second lid 450 may include a plunger 454 for extruding ingredients. The plunger 452 may furthermore include a flexible seal around its perimeter to ensure contact (e.g., maximum contact) with the sidewall of the bowl 352 to allow for optimal (e.g., maximum) extrusion yield. When the lid 450 is coupled to the bowl 352 (e.g., via reciprocal threading on the bowl and lid), the bowl assembly 350 may be considered to be in an extruding configuration, and may be coupled to the housing via coupling 500. The lid 450 may have locating and locking elements 452 on its exterior sidewall configured to couple to the locating and locking elements on the inner surface 502 of the coupling 500.

The second end 352b of the bowl 352 may include a centrally located opening 604, or an opening that is not centrally located, including a coupling collar 606. The coupling collar 606 may include threading or other types of coupling features, for example, slots or cams, e.g., for bayoneting. The opening 604 may be enclosed by a cap 605, for example, during processing, which cap may be removed during extruding. The cap 605 may include interior threading (not shown) or other coupling features that allow it to couple to the coupling collar 606. The opening 604 may further be in fluid communication with a nozzle 608. For example, the opening 604 may be in fluid communication with a nozzle through a conduit (e.g., plastic tubing) that extends from the opening 604 to the nozzle 608, e.g., within nozzle assembly 603. In embodiments, such a conduit may include one or more sections connected by joints (e.g., an elbow joint) to translate the direction (e.g., horizontal) of extrusion from opening 604 to a direction (e.g., vertically downward) of extrusion from the nozzle 608.

As shown in FIG. 1D, the user may attach the first lid 440 to the bowl 352 and couple the bowl assembly 350 to the micro-puree machine 10 using the coupling features described herein. The lid 440 may be configured (e.g., as described in the '754 patent) such that, when the lid 440 is coupling to the housing 120, the blade 300 engages a driven shaft 250 and disengages the lid 440. Through use of a user interface (e.g., as described in the '057 patent), the user may activate a program that controls the blade 300 to rotate and move (e.g., descend or move horizontally or at an angle) into the ingredients in the bowl 352 to process (e.g., micro-puree) them. It should be appreciated that in some embodiments, as shown in FIG. 1D, the nozzle assembly 603 or one or more components thereof (e.g., nozzle 608) may be coupled to the second end 352b of the bowl 350 (and perhaps to the housing) even when extrusion is not being performed, e.g., during processing. In such embodiments, the opening 604 may be closed, for example, using cap 605 or by other means. FIG. E is a bottom view of the bowl assembly 350 while coupled to the housing, in which the opening 604 is not covered. In actual use, the opening 604 may be closed, e.g., by cap 605, during processing, or open and coupled to the nozzle assembly 603 during extrusion.

After processing the ingredients in the bowl 352, the user then may remove the bowl assembly 350 from the micro-puree machine 10, remove the first lid 440 from first end 352a, replace it with lid 450 on the first end 352a, couple the nozzle assembly to the second end 352b of the bowl assembly 350 if not already attached, couple the bowl assembly 350 to the housing 120, and initiate extrusion via the user interface. During extrusion, the driven shaft drives the plunger 602 from the first end 352a of the bowl 352 to the second end 352b of the bowl, forcing the processed ingredients to extrude the processed ingredients through the opening 604 and through the nozzle 608.

FIG. 1F illustrates another embodiment of a nozzle assembly 603′, including nozzle 608′, which may be used to extrude processed ingredients, for example, using mechanisms and techniques described herein.

FIG. 1G illustrates another bowl assembly 350′ including the extrusion assembly 600 according to some embodiments of the disclosure. As shown in FIG. 1G, the bowl assembly 350′ may include a nozzle 608′ that is integrated with the bottom edge of the bowl 352′, for example, on the sidewall of the bowl 352′ proximate to a second end 352b′ or extending past the second end 352b′. In embodiments, the bowl assembly 350′ may be configured to be installed to the coupling 500 such that the nozzle 608′ faces vertically downwards when the bowl 352′ is properly installed. During extrusion, the movement of the plunger (e.g., plunger 454) will force the processed ingredients through the nozzle 608′. The nozzle 608′ may be selectively located on the bowl 352′ to optimize the amount of processed ingredients that can be extruded, thus minimizing the amount of yield loss after extrusion. For example, the nozzle 608′ may be located near the bottom edge of the bowl 352′, as shown in FIG. 1G. However, the disclosure contemplates that the nozzle 608′ may alternatively be located at a different longitudinal and/or radial position on the bowl 352′. Bowl assembly 350′ and/or bowl 352′ maybe be the same or different than bowl assembly 350 and/or bowl 352, respectively.

Advantageously, the micro-puree machine 10 may include a sensor (not shown) that recognizes which lid is installed into the machine 10 to restrict certain programs based on the lid functions, which may prevent user error when operating the machine 10. For example, the micro-puree machine may only activate the blade 300 when the sensor detects that the bowl 352 is installed in the first configuration in which lid 440 is coupled to bowl 350, and may only activate the plunger 602 when the sensor detects that the bowl 352 is installed in the second configuration in which lid 440 is coupled to bowl 350. For example, each of lid 440 and 450 may include distinctive physical and/or electromagnetic features, e.g., as part of locating and locking elements 442 and 452, respectively, for which coupling 500 or other elements of the micro-puree machine 10 may be configured to detect and distinguish lid 440 from lid 450.

The housing 120 may house one or more motors and a transmission system (e.g., including gearing) that drive a driven shaft (e.g., driven shaft 250) for engaging the blade 300 and/or plunger 454 when the bowl assembly 350 (coupled to lid 440 or 450, respectively) is coupled to the housing for processing or extruding, respectively, for example, as described in the '765 patent or U.S. Pat. No. 11,882,965 to SharkNinja Operating, LLC (the '965 patent), the entire contents of which are hereby incorporated by reference. For example, the one or more motors may include a first motor for driving rotation of the driven shaft 250 via the transmission, which may be used to drive the rotation of the blade 300 during processing, and, if desired (but not necessary) rotating the plunger 454 during extrusion. A second motor may be configured to move the position of the driven shaft 250, via the transmission, along its axis (e.g., back and forth; or up and down), which may be used to drive the back and forth movement of the blade 300 into and out of the bowl 350 during processing, and, if to move the plunger 454 into and out of the bowl 350 during extrusion. In embodiments, the micro-puree machine 10 may include gearboxes (e.g., high ratio gearboxes) and reinforced internals (not shown) to allow an extrusion assembly as described herein to withstand high forces and extrude thick outputs from the nozzle 608.

In some embodiments of the disclosure, a reversible bowl assembly may be used, which does not require that a lid be removed between processing and extruding. For example, the reversible bowl assembly may include: a first lid coupled at one end including a blade for processing and an opening for extruding; and a second lid at the other end including a plunger for extruding. Examples of such embodiments will now be described.

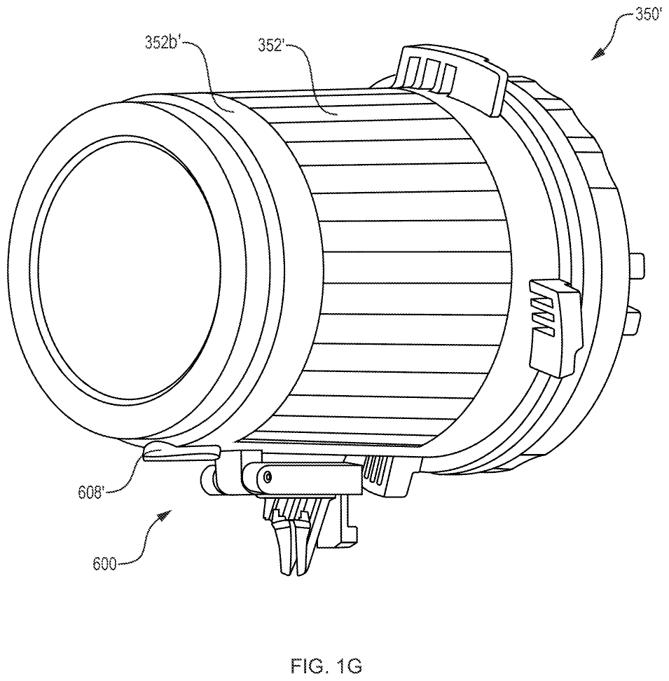

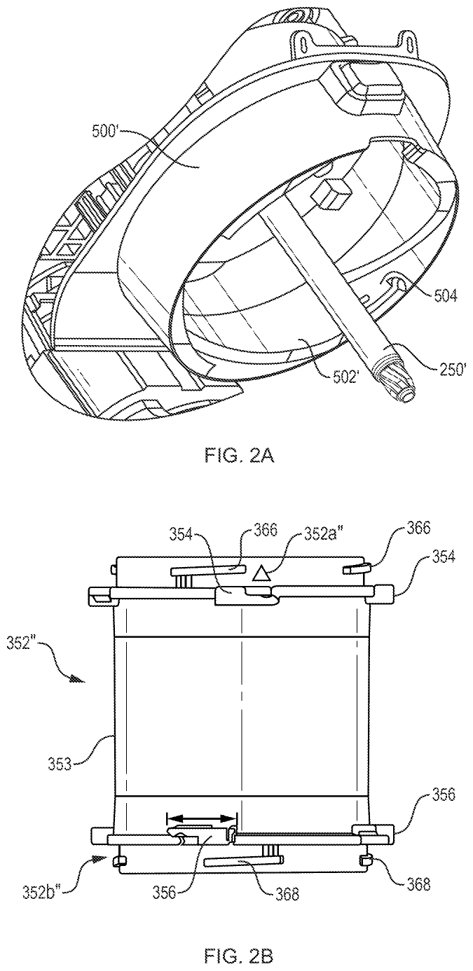

FIG. 2A illustrates an embodiment of a portion of a micro-puree machine including a coupling 500′ for coupling to a bowl assembly, for example, a reversible bowl assembly, in accordance with some embodiments of the disclosure. FIG. 2B illustrates an embodiment of a reversible bowl 352″ that may be coupled to coupling 500′. The bowl 352″ may include any of a variety of external surfaces. For example, embodiments of the bowl may have a ribbed or corrugated surface (e.g., like bowl 352 or 352′), or a smooth surface (e.g., bowl 352″). Similarly, bowls 352 and 352″ may have any variety of surfaces, including smooth surfaces.

As shown in FIG. 2A, the driven shaft 250 of the micro-puree machine 10 may extend from the housing 120 into an interior of the coupling 500′ and optionally all the way through the interior of the coupling 500′. The inner surface 502′ of the coupling 500′ may comprise one or more slots 504 sized and shaped to receive at least one projection 354 on an outer surface of a first open end 352a″ of the bowl 352″. In embodiments, both the first end 352a″ and the second end 352b″ of the bowl 352″ may be open-that is, both the first end 352a″ and the second end 352b″ may not have a top or bottom wall and/or a lid. However, the disclosure is not so limited, and one or both ends 352a″, 352b″ of the bowl 352″ may be closed with a wall or a lid. In embodiments, the at least one projection 354″ on the bowl 352″ may be four projections 354 spaced 90 degrees apart about an outer surface of the first end 352a″ of the bowl 352″. However, the disclosure contemplates more or fewer than four projections 354. In a first configuration of the reversible bowl assembly 350″, the user may rotate the bowl 352″ relative to the coupling 500′ such that the projections 354 are rotated into the slots 504, coupling (e.g., locking) the bowl 352″ and the coupling 500 together.

The slots 504 also may be sized and shaped to receive at least one projection 356 on an outer surface of a second open end 352b″ of the bowl 352″. In embodiments, the at least one projection 356 may be four projections 356 spaced 90 degrees apart about an outer surface of the second end 352b″ of the bowl 352″. However, the disclosure contemplates more or fewer than four projections 356. In a second configuration of the reversible bowl assembly 350″, the user may rotate the bowl 352″ relative to the coupling 500′ such that the projections 356 are rotated into the slots 504, coupling (e.g., locking) the bowl 352″ and the coupling 500′ together. The first end 352a″ of the bowl 352″ may further comprise threads 366 for coupling to a first lid, while the second end 352b″ of the bowl 352″ may comprise threads 368 for coupling to a second lid, as further described elsewhere herein.

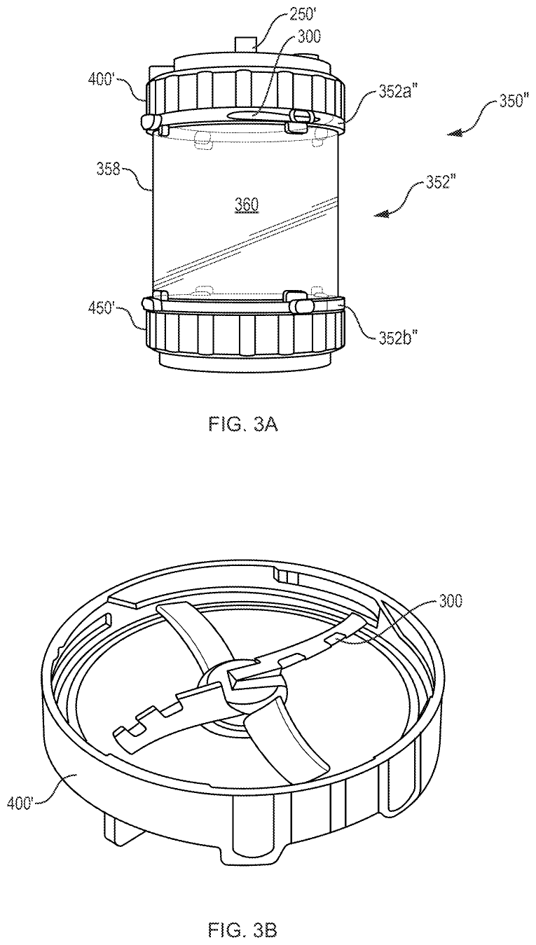

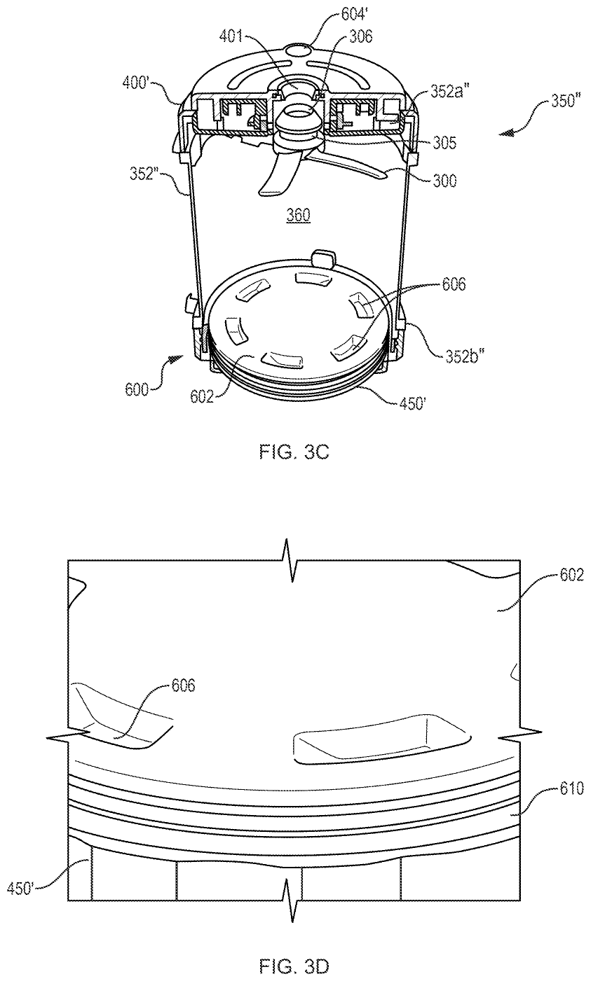

FIG. 3A shows an embodiment of the reversible bowl assembly 350″, assembled according to some embodiments of the disclosure. As shown in FIG. 3A, the bowl 352″ may have an oblong shape and include a cylindrical sidewall 358 defining an interior volume 360 of the bowl 352″. The sidewall 358 may extend between the first open end 352a″ of the bowl 352″ and the second open end 352b″ opposite the first open end 352a″. Embodiments of the sidewall 358 may have various configurations. For example, a cross-section of the sidewall may be circular or polygonal. In addition, a diameter of the sidewall may vary between the first open end 352a″ and the second open end 352b″ (e.g., may be tapered). The first open end 352a″ and the second open end 352b″ may communicate with the interior volume 360 of the bowl 352″. The assembly 350″ may further include a first lid 400′ removably couplable to the first open end 352a″ of the bowl 352″. The first lid 400′ may define an opening 401 (FIG. 3C) configured to couple to a blade 300 for mixing ingredients within the bowl 352″. When the bowl 352″ is installed to the coupling 500′ in the first configuration, the blade 300 may engage with the driven shaft 250′ to rotate and plunge the blade 300 within the ingredients. FIG. 3B shows an embodiment of the blade 300 coupled to the underside of first lid 400′. Some non-limiting examples of the blade 300 are shown in the '765 patent.

FIG. 3C is a cut-away view of the reversible bowl assembly 350″ and the first lid 400′, according to some embodiments of the disclosure, whereas blade 300 and a second lid 450′ are not shown in cut-away form. As shown in FIG. 3C, the blade 300 may include a central support hub 305 including a central opening 306 for engaging the driven shaft 250. In embodiments, the second lid 450′ may removably couple to the second open end 352b″ of the bowl 352″. The second lid 450′ may include, or be coupled to, a plunger 602 for pushing the ingredients in the bowl 352″ toward an opening 604 in first lid 400′. The plunger 602, alone or in combination with other components (e.g., the second lid 450′, the bowl 352″, or the nozzle 608), may constitute an extrusion assembly 600 for extruding processed ingredients from the bowl 352″. The opening 604′ in the first lid 400′ may further be in fluid communication with a nozzle (e.g. nozzle 608. For example, the opening 604′ may be in fluid communication with a nozzle through a conduit (e.g., plastic tubing) that extends from the opening 604′ to the nozzle. In embodiments, such a conduit may include one or more sections connected by joints (e.g., an elbow joint) to translate the direction (e.g., horizontal) of extrusion from opening 604 to a direction (e.g., vertically downward) of extrusion from the nozzle.

The plunger 602 may be couplable to the driven shaft 250′ of the micro-puree machine when the bowl assembly 350″ is in the second configuration and the bowl 352″ is installed to the coupling 500′. A surface of the plunger 602 facing the interior volume 360 may include a one or more (e.g., a plurality of) indentations 606. The indentations 606 may prevent frozen ingredients from rotational movement within the bowl 352″ during processing by the blade 300. The plunger 602 may furthermore include a flexible seal 610 around its perimeter to ensure contact (e.g., maximum contact) with the sidewall 358 of the bowl 352″ to allow for optimal (e.g., maximum) extrusion yield.

The micro-puree machine of the embodiments described in relation to FIGS. 2A, 2B, 3A-3D, 4B and 4B may include one or more motors and a transmission system (e.g., including gearing) that drive a driven shaft (e.g., driven shaft 250′) for engaging the blade assembly 300 and/or plunger 602 when the bowl assembly 350″ (coupled to lid 400′ or 450′, respectively) is coupled to the housing for processing or extruding, for example, as described in the '765 patent or the '965 patent; and may include gearboxes (e.g., high ratio gearboxes) and reinforced internals (not shown) to allow the extrusion assembly 600 to withstand high forces and extrude thick outputs from a nozzle.

FIG. 3D shows a detailed view of an embodiment of the plunger 602 coupled to the underside of second lid 450′. In embodiments, the bowl assembly 350″ may be configured such that only the first lid 400′ can couple to the first open end 352a″ of the bowl 352″ and only the second lid 450′ can couple to the second open end 352b″ of the bowl 352″. For example, a configuration of the threads 366 may be different from a configuration of the threads 368 (FIG. 3B) to prevent the user from attaching the wrong lid to the wrong side of the bowl 352″. The bowl 352″ may further include clear indicators (colors, icons, etc.) that would signal to the user which lid goes on which side of the bowl 352″.

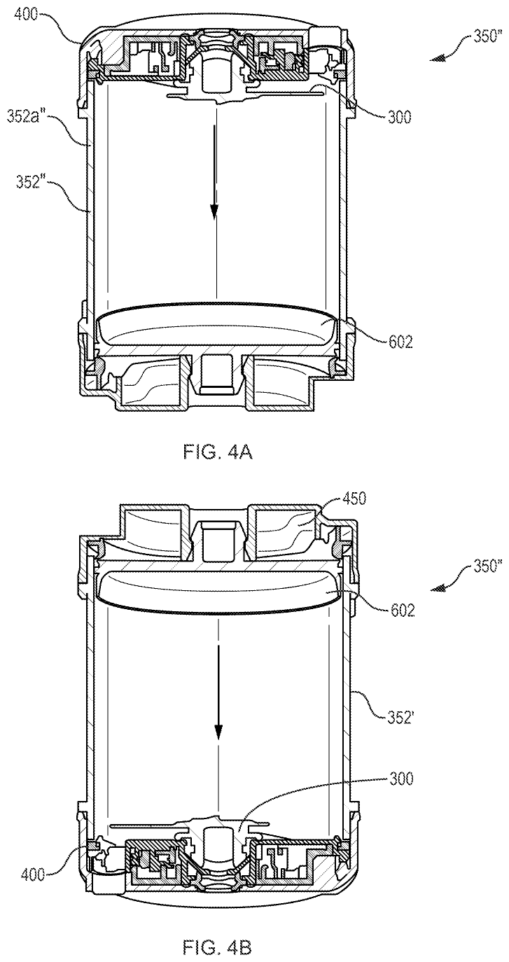

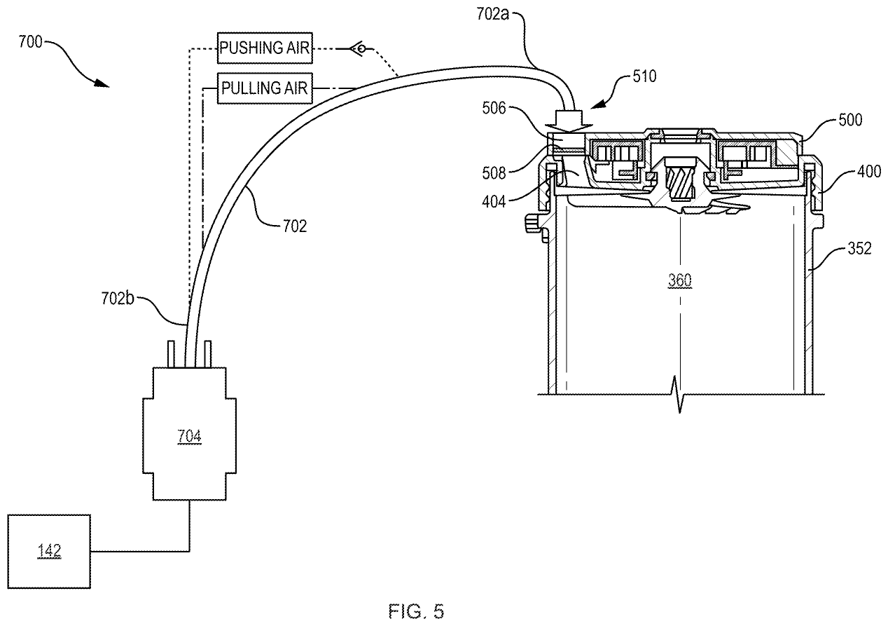

FIGS. 4A and 4B illustrate the use of the reversible bowl assembly 350″ according to some embodiments of the disclosure. As shown in FIG. 4A, a user may first install the bowl assembly 350″ to the micro-puree machine 10 in the first configuration such that the first end 352a″ of the bowl 352″ is secured to the coupling 500′. The user then may select a program at the user interface depending on the desired output (for example, soft serve ice cream, light ice cream, sorbet, gelato, etc.) to spin and plunge the blade 300 into the ingredients in the bowl 352″. For example, the blade 300 may descend into the ingredients and then ascend from the ingredients at one or more predefined rates, while rotating at one or more predefined rates. As shown in FIG. 4B, the user then may then remove the bowl assembly 350″ from the coupling 500′, reverse the orientation of the bowl assembly 350″ (i.e., flip the bowl assembly 350″) and reinstall the second end 352b″ of the bowl 352″ to the coupling 500′ in the second configuration. The user then may select a desired program at the user interface to descend the plunger 602 to extrude the ingredients out through the opening 604′ in the first lid 400′. For example, the plunger 602 may descend into the ingredients to extrude the ingredients out through the opening 604′ and then ascend from the opening 604′ after the extrusion is complete.

FIG. 5 illustrates an aeration system 700 for use with the micro-puree machine 10, according to some embodiments of the disclosure. As shown in FIG. 5, the aeration system 700 may comprise an opening 506 in the coupling 500. When the bowl 352 is in the first configuration, the interior volume 360 may be substantially sealed from ambient air. The opening 506 may include a filter 508 for filtering dust particles and debris from entering the interior volume 360. A first end 702a of a tube 702 may operatively attach to the opening 506 via a pliable stopper 510 (for example, a silicone bung) such that the tube 702 is in fluid communication with the interior volume 360. A second end 702b of the tube 702 may operatively couple to a pump 704 or other mechanism for forcing fluids (e.g., pushing air) in fluid communication with the tube 702. The pump 704 may be operable to change a pressure of the interior volume 360 of the bowl 352 by selectively pumping gas (e.g., air) into or pulling gas (e.g., air) out of the interior volume 360 during processing. The addition of air or gas to the ingredients during processing may allow a user to change a density and texture of the final product. For example, processing the ingredient under a high pressure (for example, 8 psi) results in a lighter and airier output. In embodiments, the aeration system 700 may be integrated into a processing program on the user interface 142 with a predetermined processing time and aeration percentage. The disclosure also contemplates that the user interface 142 would have a separate aeration input to allow for further user control.

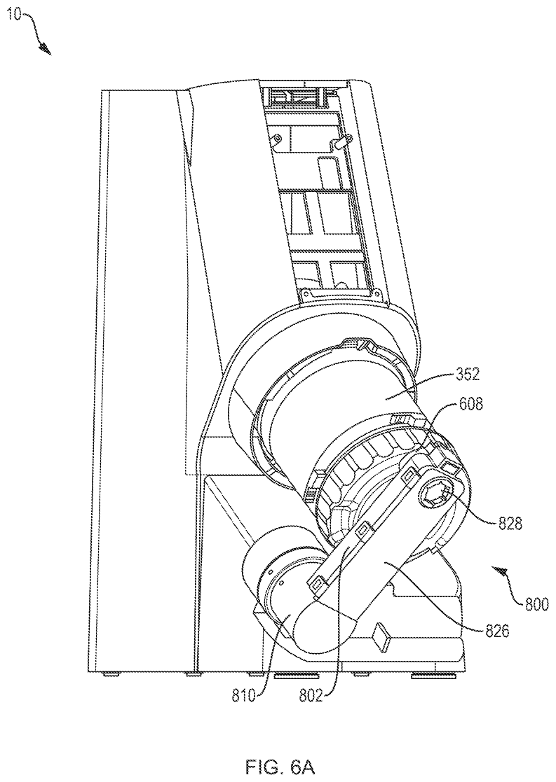

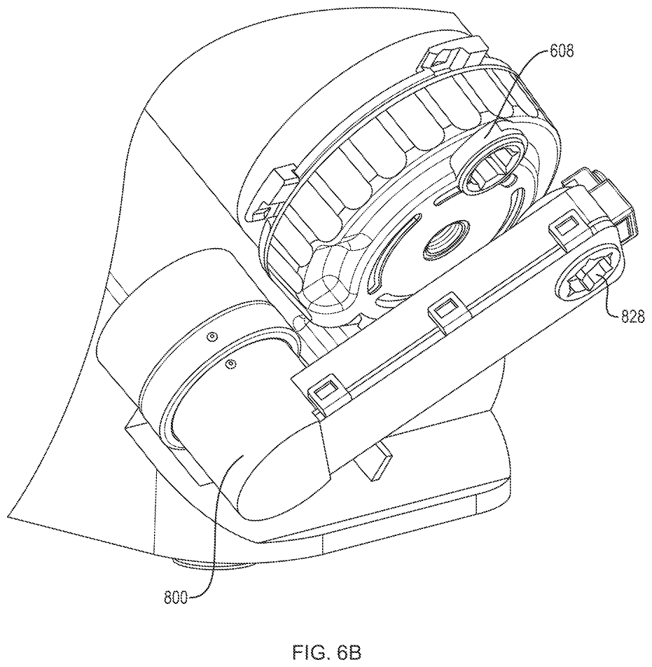

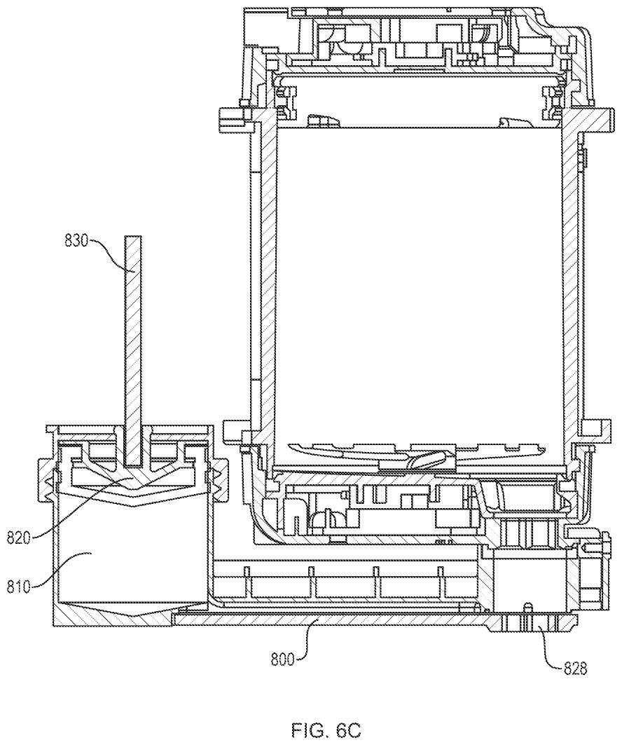

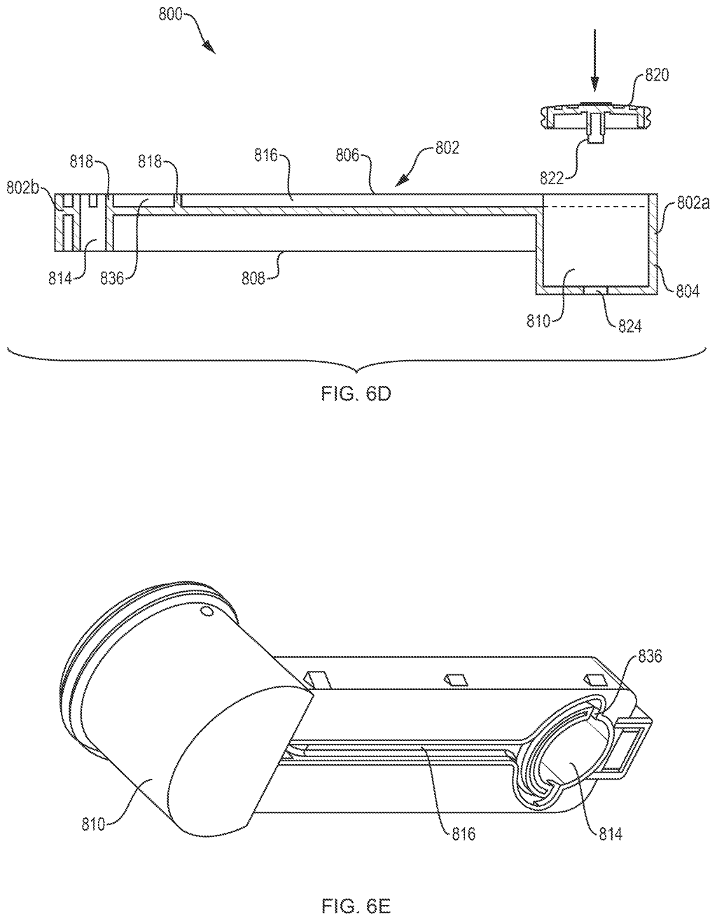

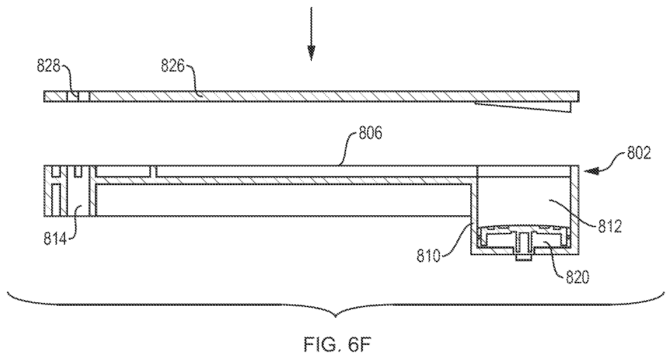

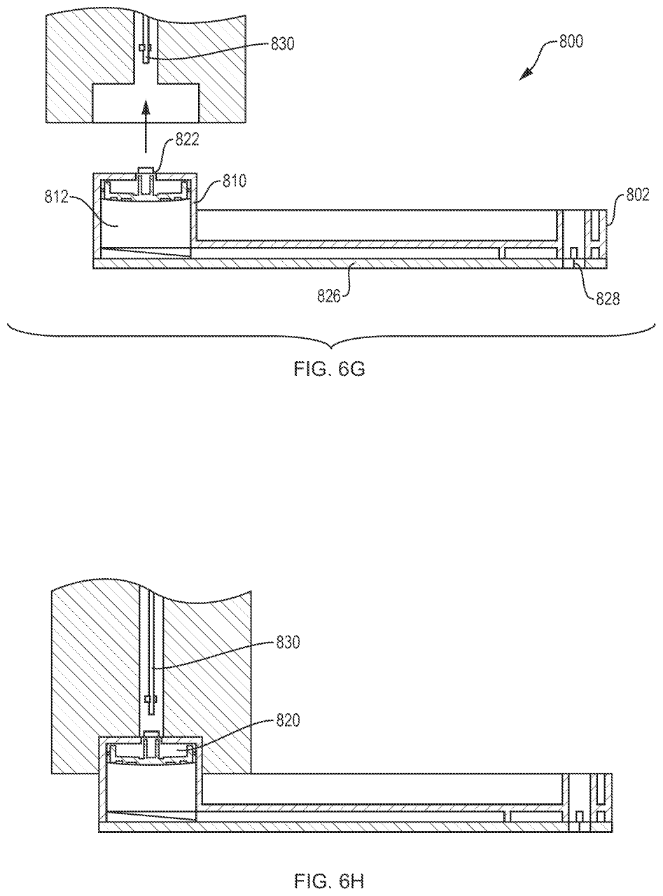

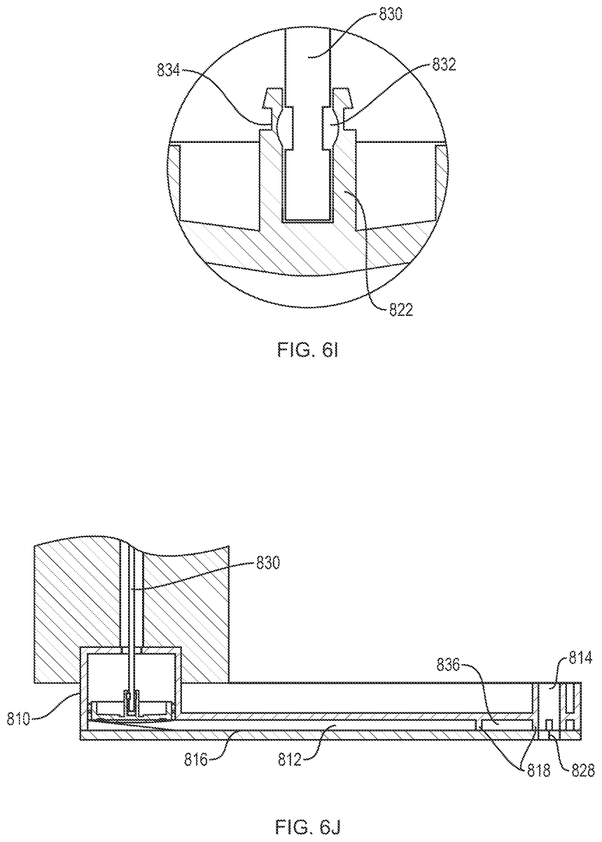

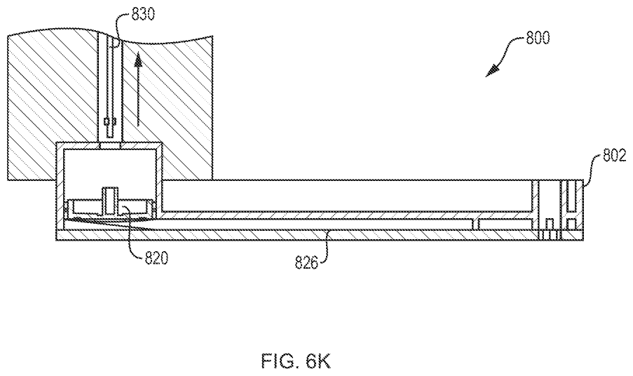

FIGS. 6A-6C illustrate an automated additive assembly 800 for use with the micro-puree machine 10, according to some embodiments of this disclosure. As shown in FIG. 6A, the additive assembly 800 may assemble to the micro-puree machine 10 and be configured for holding an additive ingredient capable of being extruded through an opening 828 in the assembly 800 along with the processed ingredients in the bowl 352. For example, the additive ingredient may be syrups, sauces, jams, and the like. Embodiments of the additive assembly 800 may generally comprise an elongated body 802 including a reservoir 810 for holding the additive ingredient, and a lid 826 including the opening 828. In embodiments, the lid 826 may form a snap fit with the body 802. However, the disclosure contemplates that the lid 826 may couple to the body 802 by another means, such as with an interference fit. FIG. 6A shows the additive assembly 800 engaged with the nozzle 608, while FIG. 6B shows the additive assembly disengaged from the nozzle 608. As shown in FIG. 6C, the additive assembly 800 may further include a plunger 820 connectable to a rod 830. The plunger 820 may be insertable into the reservoir 810 for extruding the additive ingredient through the opening 828.

FIG. 6D-6F further illustrate components of the additive assembly 800, according to some embodiments. As shown in FIG. 6D, the additive assembly 800 may comprise the elongated body 802 having at least one sidewall 804 defining an open first surface 806 and a closed second surface 808. A first end 802a of the body 802 may include the reservoir 810 defined through the body 802. A second end 802b of the body 802 may include a transverse channel 814 defined through the body 802 and alignable with the nozzle 608. A passage 816 in fluid communication with the reservoir 810 may extend toward the channel 814. The plunger 820 may be inserted into the reservoir 810 such that a connector 822 on the plunger 820 extends through a first opening 824 in the reservoir 810. As shown in FIG. 6E, the passage 816 may include a circumferential groove 836 at least partially surrounding and in fluid communication with the channel 814. As shown in FIG. 6F, after inserting the plunger 820 into the reservoir 810 from the open first surface 806, a user may fill the reservoir 810 with the additive ingredient 812 and secure the lid 826 to the open first surface 806. The interface between the lid 826 and the body 802 may enable a tight seal that prevents any ingress or leaking of the additive ingredients 812 into the machine 10. The lid 826 may define a second opening 828 in communication with the channel 814, and which may be fluidly connected to the nozzle 608 (FIG. 6B).

FIGS. 6G-6K illustrate the use of the additive assembly 800, according to some embodiments of the disclosure. As shown in FIG. 6G, once the reservoir 810 has been filled with the additive ingredient 812 and the lid 826 has been secured to the body 802, the user may invert the body 802 such that the connector 822 is attachable to a rod 830 on the micro-puree machine 10. The user may further arrange the additive assembly 800 such that the opening 828 in the lid 826 is in fluid communication with the nozzle 608. In embodiments, the rod 830 may be configured to operate separately from the driven shaft 250. However, the disclosure contemplates that the rod 830 may be operably connected to the driven shaft 250. As shown in FIG. 6H, the user may activate a setting on the user interface 142 to move the rod 830 axially toward the plunger 820. As shown in FIG. 6I, the rod 830 may then engage the plunger 820. For example, the rod 830 may engage the plunger 820 by the engagement of a circumferential projection 832 on the rod 830 with a corresponding groove 834 on an internal surface of the connector 822. However, the disclosure contemplates other suitable engagement means between the rod 830 and the plunger 820. As shown in FIG. 6J, axial movement of the plunger 830 through the reservoir 810 may force the additive ingredient 812 into the passage 816 and the groove 836 such that the additive ingredient 812 flows though the channel 814 and out through the opening 828. As such, the additive ingredient 812 may be “swirled” into the processed ingredients extruded from the bowl 352. As shown in FIG. 6K, once the additive operation is complete, the rod 830 may automatically disengage from the plunger 820. The user may then disassemble the additive assembly 800 from the micro-puree machine 10. Advantageously, the lid 826 and the plunger 820 may be removed from the body 802 for easy cleaning of the component parts.

In embodiments, the additive assembly 800 may be powered by a motor that is separate from the one or more motors operating the driven shaft 250 to allow for precise user control over both when the additive ingredient 812 is added, as well as the amount of the additive ingredient 812 added. If the user decides not to use all of the additive ingredient 812, the additive assembly 800 can be removed from the micro-puree machine 10 and stored for later use. High ratio gearboxes and reinforced internals in the micro-puree machine 10 may allow for the additive assembly 800 to withstand the high forces necessary to extrude thick ingredients.

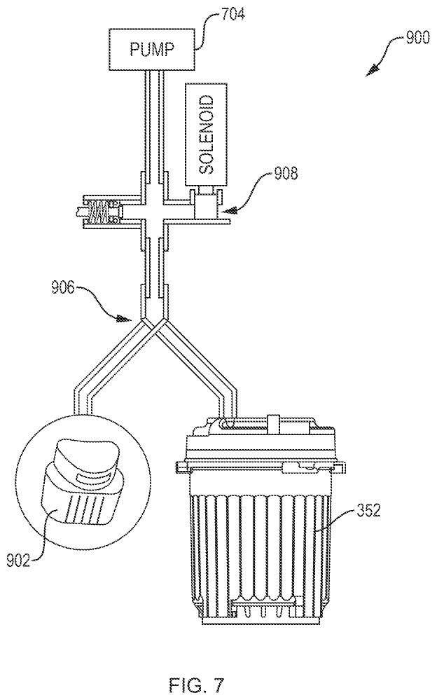

FIG. 7 schematically illustrates another automated additive assembly 900 for use with the micro-puree machine 10, according to some embodiments of this disclosure. As shown in FIG. 7, the automated additive assembly 900 may use the air pump 704 (FIG. 5) configured to be in fluid communication with both a pod 902 containing the additive ingredient 812 and the bowl 352. The air pump 704 may configured to pressurize the pod 902 to extrude the additive ingredient 812 through the nozzle 608. A change over valve 906 may redirect the air flow based on which function is selected-i.e., between pressurizing the bowl 352 during processing and pressurizing the pod 902 during extrusion of the additive ingredient. A solenoid valve 908 may be configured to open at the end of the extrusion cycle to release the pressure in the pod 902.

The disclosure contemplates that, in some embodiments (not shown), the bowl 352 can be coupled vertically in an inverted orientation (i.e., downward) on a top or upward-facing surface of the housing 120 whereby blade 300 moves up and then down to creamify, process, and/or mix ingredients in the bowl 352. The upward-facing surface may face vertically upward or be angled in an upward direction. In some embodiments, micro-puree machine 10 may be configured to automatically detect a size of the bowl 352 and, in response to the detection, extend the blade 300 a depth and/or travel distance into the bowl 352 based on the detected size of the bowl 352. This bowl-size detection would advantageously enable the micro-puree machine 10 to process ingredients in different sized containers, such as a single serve container or larger containers.

While the disclosure particularly shows and describes preferred embodiments, those skilled in the art will understand that various changes in form and details may exist without departing from the spirit and scope of the present application as defined by the appended claims. The scope of this present application intends to cover such variations. As such, the foregoing description of embodiments of the present application does not intend to limit the full scope conveyed by the appended claims.

1. An automated additive assembly for use with a micro-puree machine, the micro-puree machine having a nozzle for extruding processed ingredients, the automated additive assembly comprising:
a body including a reservoir configured for holding an additive ingredient, the body having a channel alignable with the nozzle; and
a plunger configured for movement within the reservoir;
wherein movement of the plunger within the reservoir in a first direction forces the additive ingredient into the channel.

2. The automated additive assembly of claim 1, wherein the body further comprises a passage in fluid communication with the reservoir and the channel, and wherein movement of the plunger within the reservoir in the first direction forces the additive ingredient through the passage.

3. The automated additive assembly of claim 2, wherein the passage includes a circumferential groove at least partially surrounding and in fluid communication with the channel.

4. The automated additive assembly of claim 1, further comprising a lid configured to be secured to an open first end of the body such that an interface between the lid and the body forms a seal.

5. The automated additive assembly of claim 4, wherein the lid defines an opening in communication with the channel, the opening configured to fluidly connect to the nozzle.

6. The automated additive assembly of claim 1, wherein a connector on the plunger extends through an opening in the reservoir.

7. The automated additive assembly of claim 6, wherein the connector is configured for attachment to a rod for moving the plunger within the reservoir.

8. The automated additive assembly of claim 1, wherein the automated additive assembly is configured such that forcing the additive ingredient into the channel combines the additive ingredient with the processed ingredients extruded through the nozzle.

9. A micro-puree machine comprising:
a bowl attachable to the micro-puree machine, the bowl configured to house primary ingredients within an interior volume of the bowl;
a blade for processing the primary ingredients within the interior volume of the bowl;
a nozzle for extruding the processed ingredients from the interior volume of the bowl; and
an automated additive assembly comprising:
a body including a reservoir configured for holding an additive ingredient, the body having a channel alignable with the nozzle; and
a plunger configured for movement within the reservoir;
wherein movement of the plunger within the reservoir in a first direction forces the additive ingredient into the channel.

10. The micro-puree machine of claim 9, wherein the body further comprises a passage in fluid communication with the reservoir and the channel, and wherein movement of the plunger within the reservoir in the first direction forces the additive ingredient through the passage.

11. The micro-puree machine of claim 10, wherein the passage includes a circumferential groove at least partially surrounding and in fluid communication with the channel.

12. The micro-puree machine of claim 9, further comprising a lid configured to be secured to an open first end of the body such that an interface between the lid and the body forms a seal.

13. The micro-puree machine of claim 12, wherein the lid defines an opening in communication with the channel, the opening configured to fluidly connect to the nozzle.

14. The micro-puree machine of claim 9, wherein a connector on the plunger extends through an opening in the reservoir.

15. The micro-puree machine of claim 14, wherein the connector is configured for attachment to a rod for moving the plunger within the reservoir.

16. The micro-puree machine of claim 9, wherein the micro-puree machine is configured such that the forcing the additive ingredient into the channel combines the additive ingredient with the processed ingredients extruded through the nozzle.

17. A method of adding an additive ingredient to processed ingredients in a micro-puree machine, the method comprising:
processing the ingredients within a bowl of the micro-puree machine, the bowl configured to allow extrusion of the processed ingredients through a nozzle; and
adding an additive ingredient to the processed ingredients with an automated additive assembly, the automated additive assembly comprising:
a body including a reservoir configured for holding an additive ingredient, the body having a channel alignable with the nozzle; and
a plunger configured for movement within the reservoir;
wherein movement of the plunger within the reservoir in a first direction forces the additive ingredient into the channel.

18. The method of claim 17, further comprising adding the additive ingredient to the reservoir.

19. The method of claim 17, further comprising moving the plunger through the reservoir such that the additive ingredient is moved out of the reservoir and extruded from the channel while the processed ingredients are extruded through the nozzle.

20. The method of claim 17. further comprising operatively connecting the plunger to a rod for moving the plunger through the reservoir.
